(19) United States
(12) Patent Application Publication
(10) Pub. No.: US 2015/0320100 A1
(43) Pub. Date: Nov. 12, 2015

(54) DEVICE FOR TREATING BEVERAGES HAVING WALL ELEMENTS MADE OF PLASTIC

(71) Applicants: Johann HÜTTNER, (US); Martin SEGER, (US); Jan Karsten MÜNZER, (US)

(72) Inventors: Johann Huettner, Mallersdorf-Pfaffenberg (DE); Martin Seger, Neumarkt i.d. Opf. (DE); Jan Muenzer, Harrislee (DE)

(21) Appl. No.: 14/650,122

(22) PCT Filed: Dec. 10, 2013
(86) PCT No.: PCT/EP2013/076053

§ 371 Date: Jun. 5, 2015

(30) Foreign Application Priority Data
Dec. 12, 2012 (DE) 10 2012 112 159.1

(51) Int. Cl. A23L 2/48

(52) U.S. Cl. CPC A23L 2/48; A23V 2002/00

(57) ABSTRACT

A device is provided for treating beverages having at least one conduit for passing a flowable medium and having at least one wall element. The wall element is made from a plastic and at least one cavity is formed in the wall element.

The present invention relates to a device for treating beverages and/or containers. The device will be described with reference to a pasteurisation system, however, it is pointed out that the invention can also be applied to other facilities for treating liquids and in particular beverages, such as for example cooling units, heating units or cleaning machines. Such devices are known from the prior art.

Usually, wall elements and in particular doors made from stainless steel are used in facilities such as pasteurisation and cleaning machines. If required, such doors may even have to be implemented in two parts, in particular if sound insulation is required. Such insulation will then be encapsulated by the doors or wall elements, which resulted in additional complex designs and welding operations. Further, such door elements are relatively heavy.

In the prior art, also covers for the lateral surfaces or roofs are made from thin stainless steel sheets. In this process, thin metal steel plates are normally edged and welded, and subsequently further design elements such as handles and seals are mounted. If in addition an insulating effect is to be achieved, an insulating material, for example in the form of insulating wool or insulating plates, is applied and concealed with a further stainless steel cover.

A door then consists of two metal sheets, between which an insulating material is encapsulated. Thus, the production of wall elements and in particular of insulated stainless steel doors is complex and expensive and the doors themselves become heavy. The processed metal sheets are thin and therefore sensitive to robust handling in daily use. As a result of being placed on the floor and due to their weight, the surfaces become unsightly and scratched over time and the edges get bent. Although any plastic materials used are stable in a cold condition, however they are not temperature resistant, and conversely, temperature resistant plastics are expensive.

The present invention is therefore based on the object of improving the production of such elements and thus also of the entire apparatus and to allow in particular a less costly series production. According to the invention, this object is achieved by the subject matter of the independent patent claim.

Advantageous embodiments and developments are the subject matter of the dependent claims.

A device according to the invention for treating beverages and/or for treating containers has at least one conduit for passing a liquid or a flowable medium (also a gaseous medium would be conceivable), and apart from that also at least one wall element.

According to the invention, the wall element includes a plastic, and at least one cavity is formed in the wall element. In this connection it is also conceivable that this cavity remains empty, however, it would also be conceivable for a further material to be inserted into the cavity. Advantageously, the wall element itself is formed as a hollow body.

It is thus proposed to form the wall element preferably as a hollow body element made from plastic. Such a plastic hollow body element may have an outer wall that preferably surrounds, at least partially and preferably completely, a hollow body provided on the inside of this outer wall. In this way it is possible to produce stable wall elements in a low-cost manner. This cavity may remain unfilled, but it would also be possible for further elements such as insulation elements, but also electric cables and/or liquid conduits to be provided in the cavity. Preferably, the wall element forming the hollow body is made from a plastic. Preferably, this wall element is formed in one piece. It is also possible for this cavity to be segmented and/or for support elements to be located within the cavity. Thus, for example in an area of this cavity, an insulation element may be provided, and a conduit may be provided in a further area of the cavity. It would also be conceivable for a conduit enclosed by an insulation element to be located in the cavity.

Therefore, the invention generally proposes to use moulded hollow bodies from plastics for the wall element. In a further advantageous embodiment, an insulation body for sound insulation and/or for thermal insulation is provided in the wall element. Thus, it is for example possible for an insulation effect of the wall element formed as a hollow body to be enhanced by foaming plastic in the cavity or by inserting a prefabricated insulation material.

Advantageously, the wall element includes a plastic cross-linked by irradiation. Advantageously, the wall element is made from a plastic cross-linked by irradiation. Such a wall element may be formed in one piece or in multiple pieces. If the wall element is made up of multiple components, then at least one of these components includes or consists of a plastic cross-linked by irradiation. In this case, a plurality of components preferably includes or consists of a plastic cross-linked by irradiation.

It is therefore proposed to produce now the steel or metal wall elements so far used in the prior art and in particular door elements from a plastic. In particular, the wall element is a door element, i.e. in particular an element that is movable and in particular pivotable in relation to at least one further component of the device. In an advantageous embodiment, the wall element is an outer wall or part of an outer wall of the device.

Plastics cross-linked by irradiation or materials cross-linked by irradiation are per se known from the prior art. This cross-linking by irradiation is here based on the effect of high-energy beta or gamma radiation. In this process, a plastic is exposed to a predetermined dose of gamma or beta radiation, and in this way a cross-linking of the plastic molecules is controlled in a precise manner. The material properties are defined in advance and are in particular achieved by way of very precise irradiation.

The plastic material absorbs the radiation and chemical bonds are cleaved and free radicals develop. In a subsequent step, these free radicals form a desired molecular bond. In this way, a network is achieved that is able to withstand extremely high loads. Advantageously, this modification is carried out on a finished plastic product. Preferably, a cross-linking degree within the plastic is varied, in particular by means of a shield.

Advantageously, a plastic is used in which chemical cross-linking is also possible by using radical initiators (for example peroxides). In particular, the wall element is a moulded plastic part and the plastic material is preferably a thermoplastic material, a thermoplastic elastomer or an elastomer.

Advantageously, also a locking device is further provided on the wall element, such as for example a lock or a movable latch or the like. If the wall element is a door, then the device preferably includes a frame into which this door can be closed. Preferably, this frame also includes a plastic and preferably a plastic cross-linked by irradiation. However, it would also be possible for the frame to be made from a metal.

In a further advantageous embodiment, the wall element may also include a passage for passing a liquid. In a further advantageous embodiment, a handle element is provided on the wall element, by means of which the user may for example grip and move the wall element.

In a further advantageous embodiment, the wall element has at least one undercut or one indentation.

Advantageously, at least one surface of the wall element has a wall thickness that is between 1 mm and 10 mm, preferably between 2 mm and 8 mm and particularly preferably between 2 mm and 6 mm. The applicant has determined that these wall thicknesses are particularly suitable on the one hand for achieving sufficient stability and on the other hand for achieving low production costs.

As a result of the cross-linking by radiation it is conceivable that thermoplastic materials be- come thermelastic. In this context, the cross-linking reactions may result in a network that eliminates the flowability of the plastics, as a result of which the material will behave like an elastomer under elevated temperatures. Thus, for example, the thermal resistance can be enhanced and also the thermal expansion can be adjusted in a targeted manner. Moreover, also the ageing resistance as well as the so-called glow wire resistance may be enhanced.

In a further advantageous embodiment, the plastic is selected from a group of plastics consisting of polypropylene homopolymer (PP-H), high density polyethylene (PE-HD), polyethylene of a high molecular weight (PE-HMW), polyoxymethylene copolymer (POM-C), polysulfone (PSU), polyvinylidene fluoride (PVDF), polytetrafluorethylene (PTFE), polycarbonate (PC), polypropylene with 30% glass fibre (PPGF30), polyvinylidene fluoride with 20% glass fibre (PVDFGF20) and the like. Moreover, also the use of polyamides (PA), of polybutylene terephthalate (PBT), of chlorinated polyethylene (PE-C) and the like would be conceivable.

The wall or door element preferably is a sintered element. In general it would also be conceivable for the door or wall elements to be produced using a process of thermoforming or sintering and for example of rotational sintering. It is generally pointed out that the invention is described with reference to such devices that have a conduit element for liquids. This conduit element may substantially be any element such as a pipeline, but also a reception unit for receiving a liquid. Apart from that, however, it may generally be any conduit element that passes a flowable medium such as optionally also gas.

If the rotation sintering method is used for producing the wall element, a mould for producing the component is rotated preferably about the at least two axes during the production process. Further, the material is heated, and for this purpose in particular a gas burner is provided. Apart from that, also an additional targeted heating or cooling by hot air and cold air nozzles is possible. In this way it is conceivable to produce components with different wall thicknesses.

Thus, the plastic wall elements described here may also be used on different devices generally for treating containers such as for example on blow moulding machines or on filling machines. In particular, these plastic wall elements may be used for high-noise machines or machines covered with panels, i.e. in general for any doors and covers on machines in a filling system. In the case of the above-mentioned thermoforming, the problem arises that as a result of its memory effect, the plastic does not maintain a stable shape under the effect of heat. For this reason, the plastics become able to support higher loads as a result of the cross-linking by irradiation.

In a further advantageous embodiment, the wall element is formed to have a seamless surface. In this way, not only an aesthetic advantage is achieved, but the wall element is in particular more able to withstand external loads and ages more slowly.

In a further advantageous embodiment, the wall element is formed in multiple pieces. Thus, as mentioned, an insulation body may be provided in the wall element, however it would also be conceivable for the wall element itself to be made up from several assembled parts.

In a further advantageous embodiment, the device is selected from a group of devices consisting of pasteurisation units, heating units for liquids, cooling units for liquids, cleaning units and the like. As a shaping method for the wall element, for example also injection moulding may be used, which is suitable for example for thermoplastics, thermosetting plastics and elastomers. The advantage of this method is that only one work process is needed for producing even complex geometries and almost any desired dimensions. Apart from that, however, also a high accuracy can be achieved. Moreover, also thermoforming would be possible as a production process, i.e. a forming method which is however only possible in the case of thermoplastics.

In a further advantageous embodiment, the device includes a heating unit for heating a liquid. In particular, this is an electrically powered heating unit. Advantageously, the device also includes at least one heat exchanger, preferably a liquid/liquid heat exchanger. In a further advantageous embodiment, the device also includes a transport unit for containers to be filled. This transport unit may also be formed, in sections, as a conveyor belt. Advantageously, this is a heating unit that is suitable for heating a liquid to a temperature between 45° and 85° C.

Advantageously, also post-processing is provided for this purpose, such as for example releasing the actual workpiece. Thus, for example, a surface may be post-processed or certain openings may be closed in the course of the post-processing. The type of post-processing is here dependent on the method used for the production. In particular, this type of production or the use of the plastic parts is suitable for the door of the device, because large numbers of these are produced every year and their production as a metal sheet part, as has been done so far, was very complex. Further, there are no high requirements on statics placed here. On the other hand, however, in particular in the case of the use as a door of a pasteuriser, high requirements are placed on the material because of the detergents, hot water and high temperatures used. Apart from that, also the different heat expansions between a plastic door and a steel frame have to be taken into consideration. This means that advantageously the plastic door is provided in a steel frame.

As further production methods, for example also vacuum forming may be considered, wherein a plastic plate is heated to a forming temperature, subsequently the plate is attracted by generating a vacuum, and finally the cooled moulded part is removed. Apart from that, also high pressure forming may be used wherein the plastic plate is also heated, is subsequently moulded from the top in a positive mould with a high air pressure, further the moulded part is cooled and is finally subjected to post-processing. Also so-called twin-sheet forming is possible, wherein two or more plates are heated, which are subsequently welded between the tool halves, after that high pressure is introduced through an opening and vacuum suction is applied to both tool halves.

Post-processing or finishing may be carried out for example by way of 5 axis CNC milling, 3 axis CNC milling, punching, surface treatment, welding and the like.

Moreover, the materials respectively used as plastics may also include additives such as for example PU additives.

The present invention further relates to the use of plastic hollow bodies for a wall element of a device for treating flowable media and in particular liquids and/or of a device for treating containers. Advantageously, this plastic is used for a door element or a cover element.

Advantageously, the described device includes at least one housing that surrounds an element of the device at least in sections.

Apart from that it is also possible to cast inserts such as threaded inserts into such a component. Such threaded inserts may consist for example of brass or VA. Apart from that it is also possible to insert design elements into the wall elements. Advantageously, the plastic hollow body includes a plastic cross-linked by irradiation.

Further advantages and embodiments will become evident from the attached drawings, wherein:

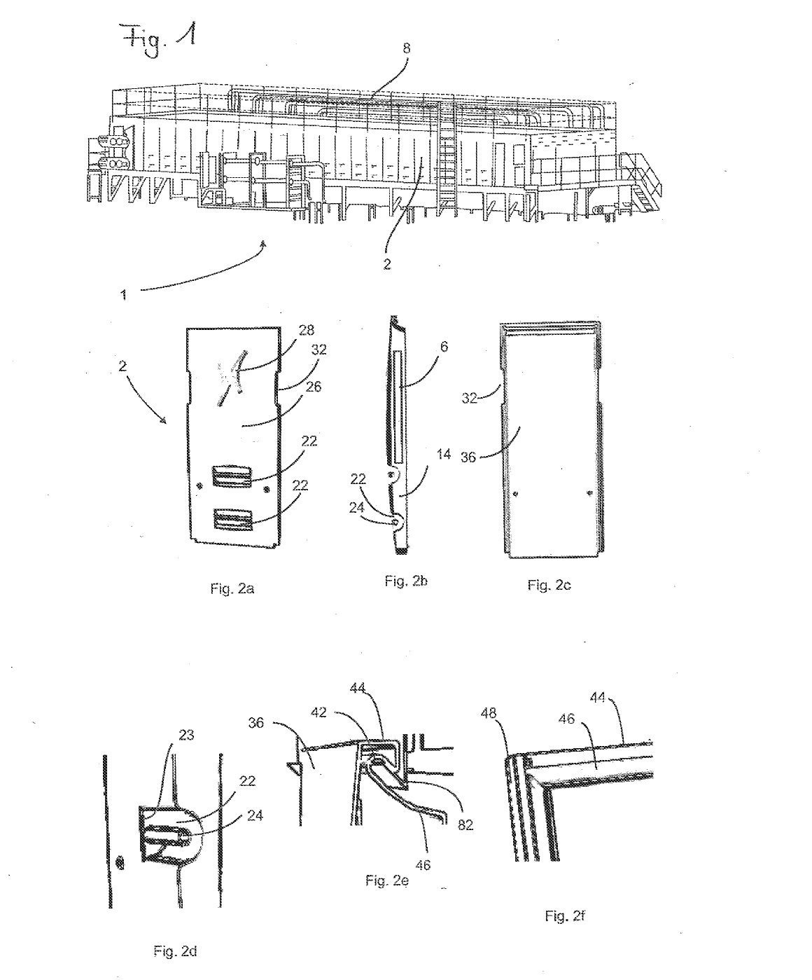

FIG. 1 shows a schematic view of a device according to the invention for treating liquids; and

FIG. 2a-2f show views of a wall element for such a device.

FIG. 1 shows a view of a device 1 according to the invention, here in the form of a pasteuriser 1. This device includes a plurality of conduits 8 for passing liquids, wherein here only those parts of the conduits can be seen that are located outside of the housing 10 of the device 1. Reference numeral 2 identifies a wall element of the device, here a door. The device includes here a multiplicity of such doors, so that accessibility is facilitated. More specifically, a plurality of such wall elements 2 or doors are here provided next to each other along a lateral surface of the device 1.

FIG. 2 shows a front view of such a wall element 2. This wall element 2 has two engagement elements 22 which a user of the wall element 2 can grip in order to open it. Apart from that, indicia such as a manufacturer's logo 28 or a name may be worked into the external surface of the wall element 2. These indicia, too, may be worked in as early as during the production of the wall element. Reference numeral 32 identifies lateral recesses, in which for example hinge elements may be provided, and these elements, too, may be formed from a plastic and may be formed integrally with the wall element.

FIG. 2b shows a lateral view of the wall element shown in FIG. 2a. It can be seen that a cavity 14 is formed on the inside of the wall element. In this cavity, an additional insulating body 6, in particular for thermal insulation and/or for sound insulation, may be provided. Apart from that, however, also conduits may be provided within the wall element 2, especially if this is not a door, but for example a roof element, for example conduits for a beverage. Within the engagement element 22, a handle element 24 such as for example a handle bar may additionally be provided here. This handle element, too, may be formed integrally with the engagement element or the hollow thereof.

However, it would also be conceivable for the cavity 14 to be completely filled with an insulating body or for the cavity 14 to be in turn subdivided into several chambers. It would also be conceivable for through-openings to be provided in the wall element, through which for example conduits such as in particular, but not exclusively, electric cables and/or liquid conduits and/or gas conduits may extend.

FIG. 2c shows a rear side of the wall element 2 with a rear surface 36. This rear surface 36 may be formed to be planar and in particular also to be seamless. However, it would also be possible for certain elements, such as for example engagement elements, threaded inserts and the like to be provided on this surface. Also, electrical interfaces may be integrated into the wall element.

FIG. 2d shows a detailed view of the engagement element 22 and it can be seen that this handle element directly extends from a partition wall 23 of the engagement element 22. FIG. 2e shows a view of the internal area of the wall element. What can be seen here is a lateral edge 44 as well as a curved section 42 extending on the inside of the wall element 2 and a further edge section 46. This further edge section may for example be pushed into an opening during the closing of the wall element and thus allow a tight closure of the wall element relative to a housing. A section 82 of this housing can be seen here.

FIG. 2f shows a further view of the wall element 2, and here both the further edge section 46 and a corner region 48 can be seen. Due to the manufacturing process, substantially any desired shapes of the wall element 2 may be created.

The applicant reserves the right to claim all of the features disclosed in the application documents as being essential to the invention, provided they are novel over the prior art either individually or in combination.

### LIST OF REFERENCE NUMERALS

1 Device

2 Wall element

6 Insulating body

8 Conduit

14 Cavity

22 Engagement element

23 Partition wall

24 Handle element

26 Surface

28 Indicia, Logo

32 Lateral recess

36 Rear surface

42 Curved section

44 Lateral edge

46 Further curved section

48 Corner region

82 Section of a housing

1. A device for treating beverages, comprising: at least one conduit for passing a flowable medium and with at least one wall element; and
the wall element includes a plastic and in that at least one cavity is formed in the wall element.

2. The device as claimed in claim 1,
wherein
the wall element includes a plastic cross-linked by irradiation.

3. The device as claimed in claim 1,
wherein
an insulating body for sound insulation and/or for thermal insulation is provided in the wall element.

4. The device as claimed in claim 1,
wherein
the plastic is selected from a group of plastics consisting of polypropylene homopolymer (PP-H), high density polyethylene (PE-HD), polyethylene with a high molecular weight (PE-HMW), polyoxymethylene copolymer (POM-C), polysulfone (PSU), polyvinylidene fluoride (PDVF), polytetrafluorethylene (PTFE), polycarbonate (PC), polypropylene with 30% glass fibre (PP GF 30), polyvinylidene fluoride with 20% glass fibre (PVDF GF20) and the like.

5. The device as claimed in claim 1,
wherein
the wall element is formed to be seamless on the surface thereof.

6. The device as claimed in claim 1,
wherein
the wall element is formed to be in multiple parts.

7. The device as claimed in claim 1,
wherein
the device is selected from a group of devices consisting of pasteurisation units, heating units for liquids, cooling units for liquids, cleaning units and the like.

8. The device as claimed in claim 1,
wherein
the wall element is produced using a method that is selected from a group of methods including vacuum forming, high pressure forming, sintering, rotational sintering, twin-sheet forming and the like.

9. The device as claimed in claim 1,
wherein
the wall element is a workpiece that is post-processed after the production thereof.

10. The use of a plastic hollow body for a wall element of a device for treating flowable media and/or a device for treating containers.
